(19) United States
(12) Patent Application Publication
(10) Pub. No.: US 2023/0333921 A1
(43) Pub. Date: Oct. 19, 2023

(54) INPUT/OUTPUT (I/O) VIRTUALIZATION ACCELERATION

(71) Applicant: Intel Corporation, Santa Clara, CA (US)

(72) Inventors: Noam ELATI, Zichron Yaakov (IL); Piotr UMINSKI, Gdynia (PL); Boris KLEIMAN, Rishon LeZion (IL); Lloyd DCRUZ, Salcette (IN); Bradley A. BURRES, Newton, MA (US); Salma Mirza JOHNSON, Littleton, MA (US); Thomas E. WILLIS, Redwood City, CA (US); Duane E. GALBI, Wayland, MA (US)

(21) Appl. No.: 18/112,382

(22) Filed: Feb. 21, 2023

(51) Int. Cl. G06F 9/54; G06F 9/455

(52) U.S. Cl. CPC G06F 9/542; G06F 9/45533

(57) ABSTRACT

Examples described herein relate to a host interface and circuitry. In some examples, the circuitry, when coupled to a physical device, is to: perform operations of a hypervisor. In some examples, the host interface is configured to route first communications to the circuitry instead of the physical device and route second communications to the physical device. In some examples, the physical device is accessible as a virtual device via the host interface.

### BACKGROUND

Cloud computing provides availability of computer resources such as compute, storage, and networking. Hardware server virtualization technology allows sharing hardware (e.g., processor, memory, input/output (I/O)) by virtual machines (e.g., guest operating systems (OS)) and containers. I/O virtualization allows a single physical adapter to be shared as multiple virtual network interface controllers (NICs). Hardware assisted I/O virtualization allows the guest OS to bypass the hypervisor and directly access a physical device using a hardware interface. Software (SW) assisted I/O virtualization exposes a virtual device (e.g., NIC) to a hypervisor and the hypervisor emulates a virtual device by translating and passing commands between the physical device and the guest OS.

### BRIEF DESCRIPTION OF THE DRAWINGS

FIG. 1 depicts an example system.

FIG. 2A depicts example system.

FIG. 2B depicts an example system.

FIG. 3 depicts an example of operations.

FIG. 4 depicts an example of multi-thread execution.

FIG. 5 depicts an example process.

FIG. 6 depicts an example system.

FIG. 7 depicts an example system.

### DETAILED DESCRIPTION

SW assisted I/O virtualization can provide more flexibility than HW assisted I/O virtualization by allowing different types of guest OS drivers to access a physical device, potentially allowing upgrading an I/O interface version to expose new features or fix a previous version of an I/O interface version. Various examples can provide a host that can offload operation to an accelerator, such as a Smart End Point (SEP), inline with a device, to accelerate operations of I/O virtualization and reduce CPU utilization in connection with I/O virtualization. For example, offloaded operations can include device emulation, which can include at least: configuration space simulation, SW or HW queueing protocol implementation, and/or descriptor conversion. In some examples, an SEP can include programmable accelerators and include processor cores and circuitry to perform scheduling of processing of events, load balancing, management of thread execution, and direct memory access (DMA) operations. A SEP can be included in or coupled to a device such as a network interface device, storage controller, packet processor, inline cryptographic accelerator (e.g., decryption or encryption), or other device.

The SEP can include embedded cores that can include memory and instruction cache to allow cores to operate independently. For example, events scheduling can latch events and schedule events for processing by one or more cores. For example, a thread manager and load balancer of the SEP can assign scheduled events to one or more cores for processing. For example, the DMA engine can copy data from host memory to SEP memory or copy data from SEP memory to device local memory. Offloaded event performance can be executed on the cores without preemption and can run to completion. Embedded cores of the SEP can perform one or more of: descriptor format translation for different drivers and different protocols and a physical device, buffer semantic conversion, or other operations. An application or process that utilizes the SEP to perform SW assisted I/O virtualization can execute in a non-virtualized environment (e.g., no use of a hypervisor) or virtualized environment (e.g., virtual machine, container, and so forth). By offloading the interface protocol implementation, event scheduling, and/or thread management to the SEP, a host processor can be freed to perform operations other than management and event scheduling operations.

Various examples of device virtualization techniques are described next. Single Root I/O Virtualization (SR-IOV) and Sharing specification, version 1.1, published Jan. 20, 2010 by the Peripheral Component Interconnect (PCI) Special Interest Group (PCI-SIG) provides hardware-assisted high performance I/O virtualization technique that provides for scalable sharing across virtualized execution environments of I/O devices, such as network interface devices, storage controllers, packet processor, packet processing pipeline, cryptographic accelerator (e.g., decryption or encryption), memory pool controllers, graphics processing units, and other hardware accelerators across a large number of virtualized execution environments. PCI Express (PCIe) is defined by PCI Express Base Specification, revision 4.0, version 1.0, published Oct. 5, 2017. Unlike the coarse-grained device partitioning approach of SR-IOV to create multiple VFs on a PF, S-IOV enables software to flexibly compose virtual devices utilizing the hardware-assists for device sharing at finer granularity. Some operations on the composed virtual device are performed by the underlying device hardware, while some operations can be emulated through device-specific composition software executed by the host. A technical specification for Scalable Input/Output (I/O) Virtualization (S-IOV) is Intel® Scalable I/O Virtualization Technical Specification (June 2018), and revisions and variations thereof.

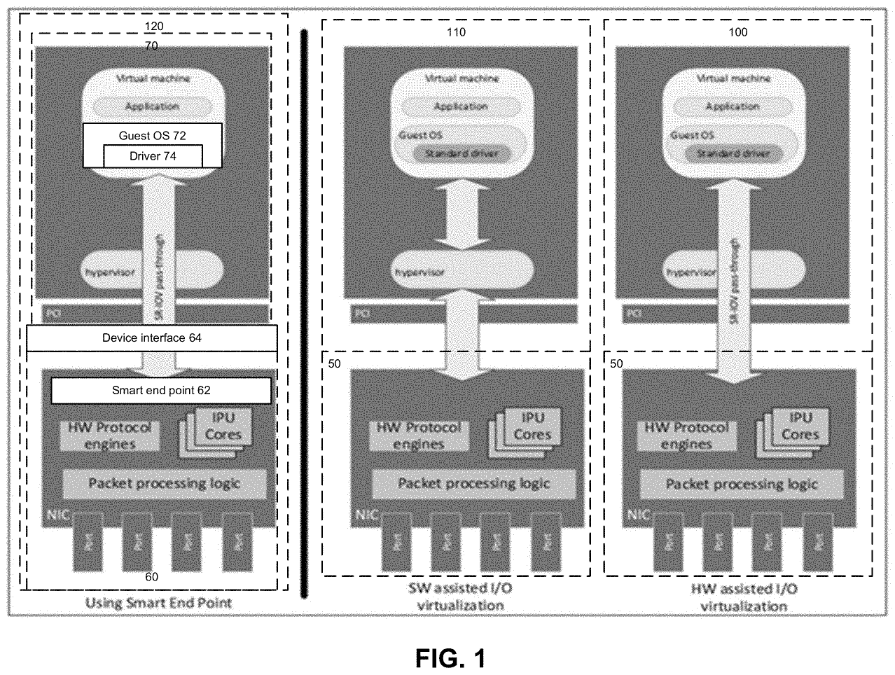

FIG. 1 depicts an example system. Configuration 100 depicts a known HW assisted I/O virtualization system using SR-IOV where a host driver communicates directly with device 50 in order to virtualize use of device 50. Configuration 110 depicts a known SW assisted I/O virtualization system where a hypervisor is used as a mediator between the host driver and the device and the hypervisor running on CPU in host is an intermediary between a driver and device 50.

In configurations 100 and 110, host systems can be communicatively connected to device 50 using a device interface (e.g., Peripheral Component Interconnect express (PCIe), Universal Chiplet Interconnect Express (UCIe), Compute Express Link (CXL), or others). In some examples, configurations 100 and 110 can be communicatively connected to device 50 as part of a system on chip (SoC) or integrated circuit. In some examples, device 50 can include one or more central processing units (CPUs), xPUs, graphics processing units (GPUs), accelerators, memory devices, storage devices, memory controllers, storage controllers, network interface devices, and so forth.

In configuration 120, to accelerate and perform operations of HW assisted I/O virtualization, SEP 62 of device 60 can be used for device emulation and SEP 62 can be exposed directly to host driver 74 using a device interface based on SR-IOV or other device virtualization technique. However, in some examples, NIC 60 can be accessible using device interface 64 based on SR-IOV or other device virtualization technique, and device interface 64 can route certain communications to SEP 62. SEP 62 can be presented as a PCIe device to guest operating system (OS) 72 for access without presenting additional or new requirements of SEP 62 or device 60 to the guest OS, hypervisor, or the physical device (e.g., NIC 60). For example, guest OS 72 can access device 60 as a virtual device using HW assisted I/O virtualization (e.g., SR-IOV, SIOV, or others) and utilize SEP 62 for device emulation operations. As described herein, cores of SEP 62 can execute routines to perform operations of a hypervisor as in SW assisted I/O virtualization and emulate a virtual device by translating and passing events (e.g., descriptors) between device 60 and guest OS 72, and other operations.

Compared to HW assisted I/O virtualization, SEP 62 can flexibly implement multiple device types and multiple versions of device interfaces and allow guest OS 72 to access future device types and future interface types. SEP 62 can perform operations that, in SW assisted I/O virtualization, could be performed by a general purpose CPU as implemented by guest OS 72 or by a hypervisor. Offloads to SEP 62 can provide a performance boost and more predictable processing latencies. Communications between SEP 62 and guest OS 72 as well as communications between guest OS 72 and device 60 can bypass hypervisor, in some examples.

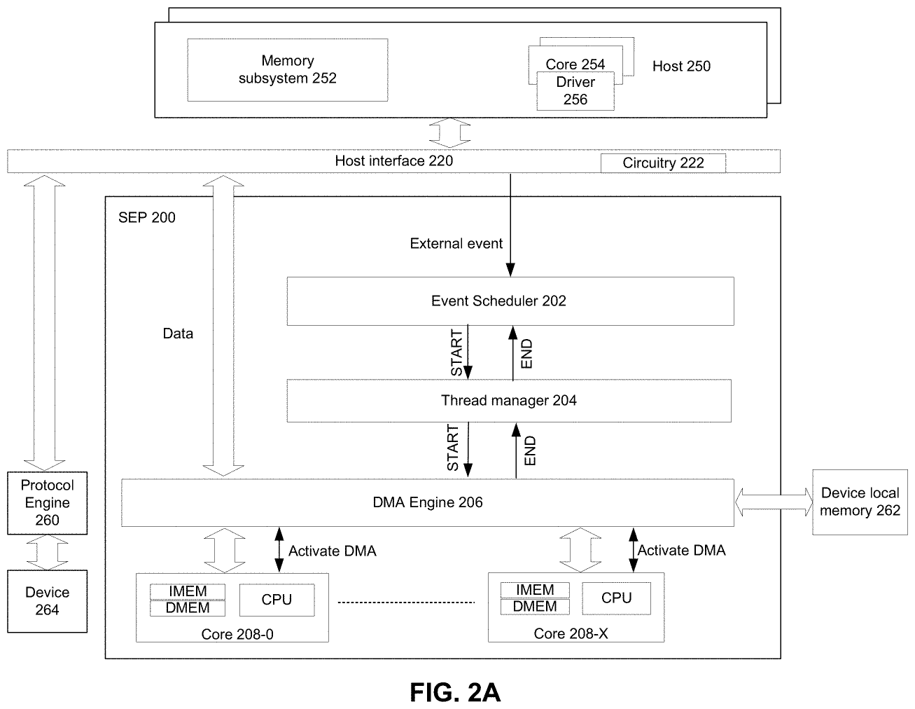

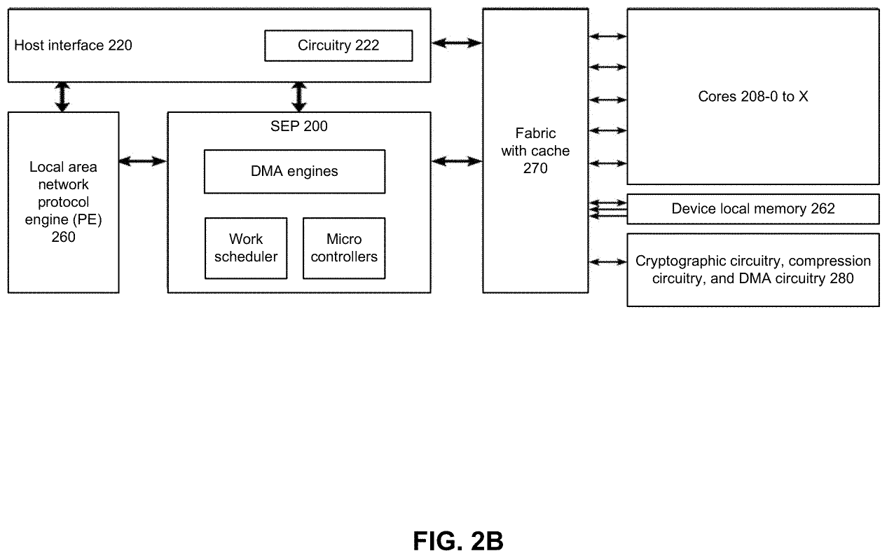

FIG. 2A depicts an example system. In some examples, host 250 can offload interface protocol translation to SEP 500. In some examples, SEP 200 can receive external events from host 250 via host interface 220. SEP 200 can receive a doorbell from driver 256 to indicate an event is available for performance or generate interrupts to driver 256 to indicate an available event. SEP 200 can be an intermediary device between host 250 and protocol engine 260 associated with device 264. In some examples, SEP 200 can access host memories 252 and the memories of SEP 200 and memory 262.

In some examples, instead of performing event scheduling by general purpose CPU cores 254 by an OS, which can consume cycles of CPU cores 254, SEP 200 can utilize event scheduler 202 to perform schedule processing of events from host 250 by one or more of cores 208-0 to 208-X, where X is an integer. In some examples, event scheduler 202 can process external events caused by doorbells triggered by host driver 256 executed by cores 254 and interrupts triggered by protocol engine 260. Event scheduler 202 can copy information (e.g., queue head pointer and/or tail pointer) associated with processing of a descriptor and perform event arbitration between pending events using predefined arbitration schemes. Arbitration schemes can include round robin, weighted round robin, first-in first-out, strict priority, or others.

In some examples, instead of performing event scheduling by general purpose CPU cores 254 by an OS, which can consume CPU cycles, SEP 200 can utilize thread manager 204 to load balance processing of events from host 250 by one or more of cores 208-0 to 208-X. One or more load balancing criteria can be applied. For example, an event can be assigned to a least utilized core to attempt to make cores equally busy or the event can be assigned to a most utilized core to a reduce a number of cores active to reduce power use. Executing core load balancing and event scheduling in circuitry in SEP 200 can provide predictable behavior and smaller processing latency jitters for latency sensitive deployments and meeting performance benchmarks.

In some examples, DMA engine 206 can copy data (e.g., descriptors or other metadata) between memory 252 and memory 262 (e.g., from memory 252 to memory 262 or from memory 262 to memory 252), between memory 252 and data memory (DMEM) (e.g., from memory 252 to DMEM or from DMEM to memory 252), or between memory 262 and DMEM or instruction memory (IMEM) (e.g., from memory 262 to DMEM or IMEM or from DMEM or IMEM to memory 262). Event scheduler 202, thread manager 204, or DMA engine 206 can communicate DMA operation start and completion times to at least one core of cores 208-0 to 208-X. DMA operation start and completion times can indicate which thread is ready to process an event or which thread is waiting for a DMA operation to complete and therefore not ready to process an event.

One or more of computational cores 208-0 to 208-X can be configured to process a specific instruction set. In some embodiments, instruction set may facilitate Reduced Instruction Set Computing (RISC), Complex Instruction Set Computing (CISC), or computing via a Very Long Instruction Word (VLIW). One or more processor cores 208-0 to 208-X may process a different instruction set, which may include instructions to facilitate the emulation of other instruction sets. A processor core may also include other processing devices, such as a Digital Signal Processor (DSP). A core can execute one or more threads. For example, a thread can include a sequence of executable instructions.

In some examples, a core can execute multiple threads that process multiple events. A portion of internal data random access memory (RAM) (e.g., DMEM) can be allocated to a thread and used as a scratchpad for storing data. A core executing multiple threads allows the core to execute a thread to process one event while the core executes a thread that waits for a DMA completion associated with another event. Using multiple threads can potentially hide DMA copy latency during memory access as one thread can process an event while another thread waits for DMA to complete and utilization of the core that executes threads can be increased.

A thread can be in one of the following states: IDLE (not allocated), READY (allocated by thread manager 204 and is ready for processing), or WAIT (allocated by thread manager 204 and waiting for an external event to end). To manage multiple threads, a core can run a main loop routine. A thread can issue a DMA command to copy data (e.g., at least one descriptor) before calling a main loop and set the thread state to WAIT. When or after the DMA command to copy the data completes, DMA engine 206 can set the thread state to READY. The core can execute a main loop to perform arbitration among threads that are in a READY state. The main loop can select a thread in READY state to commence processing of copied data. The selected thread in READY state can be permitted to execute without preemption and at completion, can call the main loop. For example, the selected thread can perform a translation between queues defined by a standard interface and queues defined by proprietary interfaces to the rest of NIC hardware. For example, the selected thread can perform descriptor format translation from a first format to a second format that can be processed by protocol engine 260. For example, the selected thread can perform other selected operations of a hypervisor.

In addition, by use of event scheduler 202 and thread manager 204, task management and event scheduling routines need not be implemented in software executed by one or more of cores 208-0 to 208-X, which can allow programs to be executed without preemption (e.g., run to complete). However, one or more of cores 208-0 to 208-X can perform task management and event scheduling. In some examples, software executed by SEP 200 can run in a bare metal environment with no real time operating system (RTOS)).

Protocol engine 260 can provide commands and communications between an OS, executed by one or more cores 254, and device 264 (e.g., a network interface device, storage device (e.g., Non-Volatile Memory Express (NVMe) drive), cryptographic accelerator, or other device) in accordance with one or more applicable application program interfaces (APIs) or protocols (e.g., NVMe or others). In some examples, SEP 200 can be used for I/O offloads and embedded cores on a NIC or other device 264 can implement protocol engine 260 and perform storage initiator operations.

Host or device interface 220 can provide communications between SEP 200 and host 250 as well as protocol engine 260 and host 250 based on a protocol, such as one or more of: Peripheral Component Interconnect express (PCIe), Universal Chiplet Interconnect Express (UCIe), Compute Express Link (CXL), or others. Host 250 can include memory system 252 and cores 254. In some examples, cores 254 can execute an OS or driver and provide an application or process (e.g., virtual machine (VM), container, microservice, and so forth) with access to SEP 200 using a virtualized interface such as a virtual function or virtual device (e.g., SR-IOV, SIOV, or others). In some examples, cores 254 can execute device driver 256 that can access device 264 and core 254 can execute another driver that can access SEP 200. Although, in some examples, cores 254 can execute device driver 256 that can access SEP 200 as though accessing device 264. An application or process can access SEP 200 on a physical function granularity, and some of the physical functions can provide access to SEP 200 but other physical functions do not provide access to SEP 200.

A hypervisor executing on one or more of cores 254 can run and manage operations of virtual machines and bind driver 256 to a virtual device associated with device 264. In some examples, driver 256 executing on one or more of cores 254 can access device 264 as a virtual device using a virtual interface. Driver 256 can write to an offset of an Base Address Register (BAR) address range accessible by device 264 to indicate an offset into memory-mapped I/O (MMIO) address space in which driver 256 can write data.

Circuitry 222 can be configured so that doorbell writes to certain BAR range(s) can cause host interface 220 to route such doorbells to SEP 220. For example, host interface 220 can be configured to write MMIO accesses into memory space of device 264 (e.g., memory 262) and write configuration space accesses to SEP 200. Examples of MMIO accesses can include host events written to MMIO space. Examples of configuration space accesses can include requests for device identifier and vendor identifier.

Host interface 220 can include circuitry 222 that is configured, by driver 256 or an operating system or hypervisor, to associate a BAR range allocated to SEP 200 and route transactions or events (e.g., descriptors or others) written to such BAR range to SEP 200. For example, software (e.g., OS or hypervisor) and/or firmware executing on a host and/or cores 208-0 to 208-X can configure circuitry 222 to forward writes to one or more BAR ranges to SEP 200 and forward writes to one or more other BAR ranges to PE 260. For example, circuitry 222 can be configured to forward writes to one or more BAR ranges to SEP 200 such as when a vendor of device 264 and a vendor of the device driver are different or the device driver and device 264 are incompatible.

Event scheduler 202, thread manager load balancer 204, DMA engine 206, protocol engine 260, and/or one or more of cores 208-0 to 208-X can be implemented as one or more of: application specific integrated circuits (ASICs), programmable control logic, and programmable processing elements such as field programmable gate arrays (FPGAs) or programmable logic devices (PLDs).

Where device 264 includes an infrastructure processing unit (IPU) or smartNIC with embedded cores, utilizing SEP 200 to perform device emulation operations for I/O virtualization can free the IPU embedded cores to execute customer software or business logic. However, IPU embedded cores can be used to perform device emulation for I/O virtualization.

FIG. 2B depicts an example system. As shown, SEP 200 can access memory of a network interface device or other device 264 using fabric 270. In addition, fabric 270 can provide communication among SEP 200, host interface 220, cores 208-0 to 208-X, device local memory 262, and cryptographic circuitry, compression circuitry, and DMA circuitry 280.

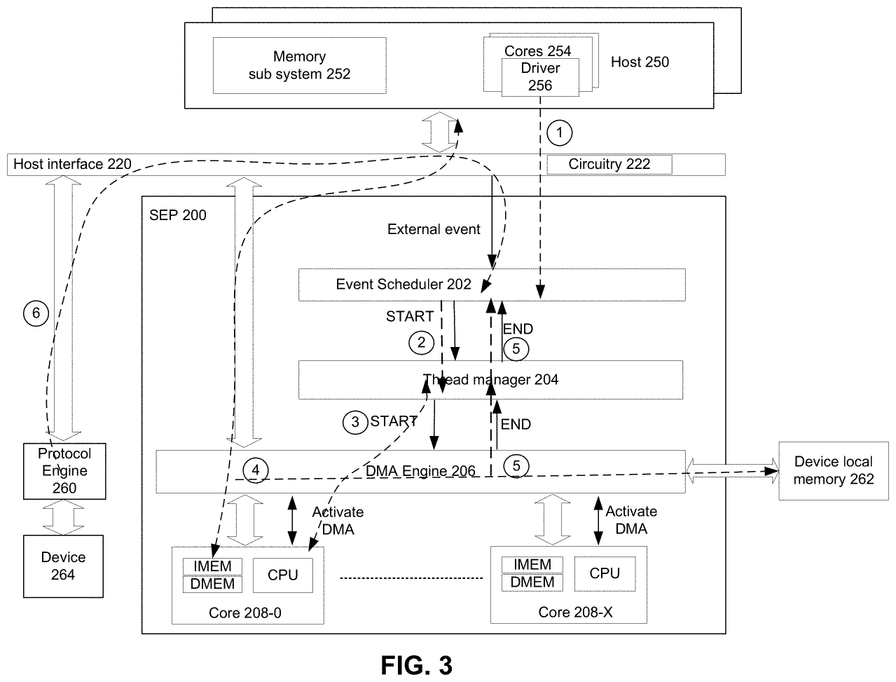

FIG. 3 depicts an example of operations. In some examples, the operations can represent operations of a single stage routine. However, a routine can be divided into multiple stages of execution separated by DMA commands execution whereby a SEP core issues a DMA operation in the end of stage N and starts processing stage N+1 when DMA command completes.

As described below, SEP 200 can perform operations of hypervisor such as interface translation, including descriptor format translation and queue semantic translation. For example, queue semantic translation can include translation of head and tail pointers and translation of memory addresses associated with a queue (e.g., descriptor queue and/or data queue). At (1), host driver 256 executing on a core of cores 254 on host 250 can indicate to SEP 200 availability of a descriptor (e.g., doorbell write) after writing descriptors to a descriptor queue in host memory 252. Based on configuration of circuitry 222, host interface 220 can route the doorbell to SEP 200. As described in (2)-(6), in response to the doorbell, SEP 200 can fetch one or more descriptors from a descriptor queue in host memory 252, process the one or more descriptors, as described herein, and copy the one or more descriptors to a descriptor queue in device local memory 262 accessible to protocol engine 260.

At (2), event scheduler 202 can decode an event associated with the copied one or more descriptors and add the event as a candidate for execution scheduling. Event scheduler 202 can select among events based on an arbitration scheme (e.g., round robin, weighted round robin, first-in first-out, or others). Pending events can include at least descriptor translation to a format that can be processed by protocol engine 260 or translation of descriptor format from protocol engine 260 descriptor format to format accessible to driver 256. Pending events can include at least descriptor translation to a format that can be processed by device 264 or translation of descriptor format from device 264 descriptor format to format accessible to driver 256. A pending event representation can be identified in event scheduler 202 by a flag (e.g., 1 bit) and a field to capture event metadata (such as descriptor queue tail offset) (e.g., one or more bytes). The selected event can be made available to thread manager 204 and thread manager 204 can select a core or thread, among cores 208-0 to 208-X, to process the selected event. One or more of cores 208-0 to 208-X can execute routines to perform descriptor translation.

Before a core or thread issues a DMA request to access data associated with the event (e.g., a descriptor), the core can set the scheduling state of the thread to WAIT to make the thread non-eligible for selection by thread manager 204. At (3), after selection of a core/thread, thread manager 204 can send a message or otherwise inform DMA engine 206 to cause a scheduling status of the thread to be set to READY and ready for arbitration.

At (4), the selected core can execute a main loop to poll the scheduling status of executed threads and arbitrate among threads in READY state to select a thread to process the event. Cores can operate without interrupts (e.g., polling mode) using a single main loop routine to arbitrate between threads in the READY state. Selection of a thread in a READY state can be based on round robin, weighted round robin, first-in first-out, strict priority, or others. A selected thread can process an event by performing one or more of (a) to (d). At (a), the DMA engine can execute the DMA command to copy the one or more descriptors to a memory accessible to the selected core (e.g., IMEM and/or DMEM). At (b), the selected thread can process the one or more descriptors from the host and translate them into descriptors of a format accepted and properly interpreted and processed by protocol engine 260. At (c), the selected thread can copy the one or more protocol engine descriptors from core local memory to device local memory 262 using DMA engine 206. At (d), the selected thread can write a doorbell to protocol engine 260 using DMA engine 206 to indicate availability of a descriptor.

For example, operations (a)-(d) can be performed in multiple stages (e.g., for cases of multiple queue indirections) whereby SEP 200 can perform processing of the host data structures and can perform descriptor translation and perform DMA of packet data (e.g., header and/or payload) or packet metadata header from memory 252 to memory 262 or memory 262 to memory 252.

At (5), based on completion of event processing by the selected thread, the selected core can set the selected thread state to IDLE and indicate to thread manager 204 that the thread is free for allocation. At (6), when or after protocol engine 260 process the one or more translated descriptors and indicates performance of the command reference by the one or more descriptors (e.g., packet transmitted, data encryption or decryption performed, or others), SEP 200 can indicate to cores 254 of host 250 that processing of the one or more descriptors has been completed. SEP 200 can read completed events from device memory 262, translate events, and copy translated events to host memory 252. Host 250 can process data received by DMA and cope with multiple queue indirections.

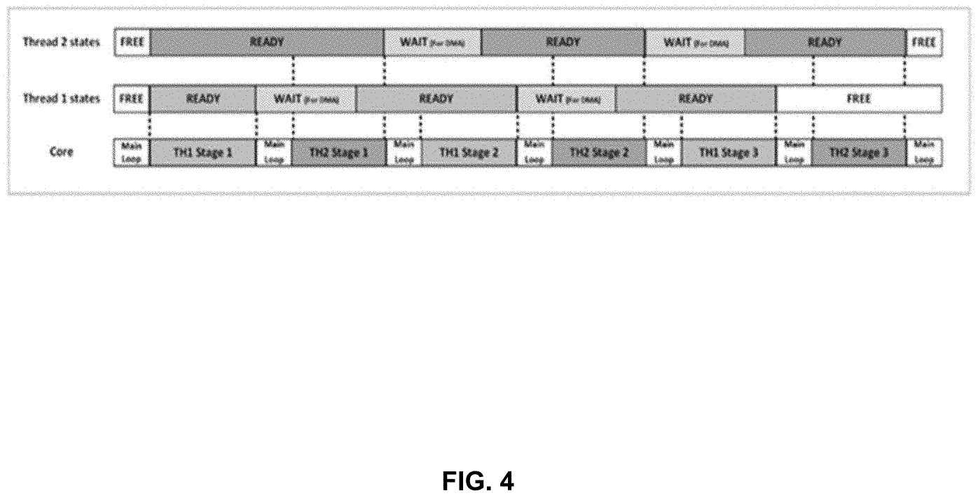

FIG. 4 depicts an example execution of two threads on a single core. In some examples, both threads can utilize DMA to perform memory accesses of one or more descriptors. When thread 1 is active or READY, thread 2 can be in a WAIT state waiting for a DMA copy operation of one or more descriptors to be completed. By overlapping READY and WAITING states of different thread, during DMA engine copy latency, another thread and the core can be kept busy.

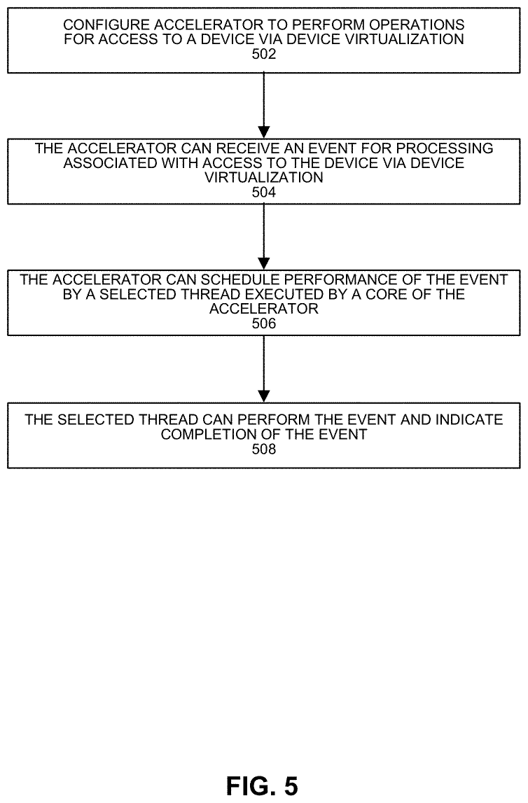

FIG. 5 depicts an example process. The process can be performed by an accelerator (e.g., SEP) connected inline between a host system and a device, in some examples. In some examples, the accelerator can be connected to a protocol engine of a network interface device, storage controller, memory pool controller, graphics processing unit, cryptographic processor, or other device. At 502, an operating system or driver executed by a host system can configure the accelerator to perform events, offloaded from a host or server, for communication with a device that is shared using I/O device virtualization. In some examples, events can include descriptor format translation into a protocol engine format descriptor and/or translation of memory addresses of buffers.

At 504, in connection with access to a device by hardware device virtualization, the accelerator can receive an event from a host interface. An event can include processing a descriptor. The host interface can be configured to route the event to the accelerator based on the event being written-to a memory region that is associated with the accelerator. At 506, the accelerator can utilize hardware circuitry to schedule performance of the event by a general purpose processor and load balance processing of the event among general purpose processors. At 508, a general purpose processor of the accelerator that is scheduled to process the event can select and utilize a thread that is available to perform the event. In some examples, the general purpose processor can copy the one or more descriptors associated with the event from the host memory to the accelerator core local memory using a DMA engine.

At 508, the selected thread can process the event. For example, processing or performance of the event can include translation of a descriptor format into a descriptor consistent with a format consistent with the protocol engine. At 508, the general purpose processor can copy the protocol-engine descriptors from core local memory to the device local memory using the DMA engine and write a doorbell to the protocol engine using the DMA engine to indicate availability of a descriptor. Thereafter, the device can perform operations associated with the descriptor. For example, the descriptor can identify content of a packet in memory to transmit as well as operations to perform on the packet (e.g., encrypt, decrypt, data write, data read, and so forth).

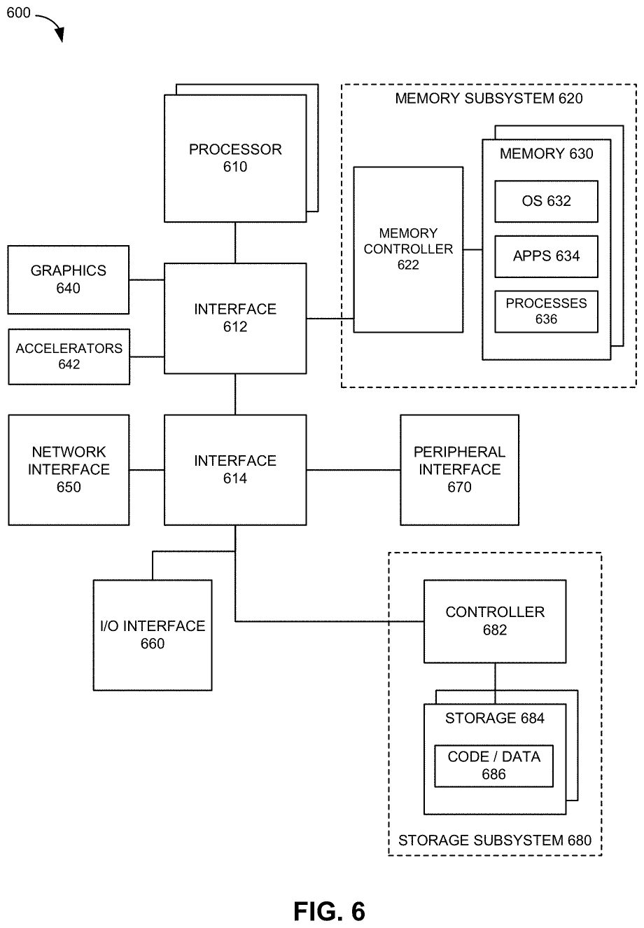

FIG. 6 depicts an example computing system. Components of system 600 can be configured to perform event processing using an accelerator in line with a device (e.g., processor 610, accelerators 642, network interface 650, memory subsystem 620, and so forth) at least where the device is accessed using device virtualization, as described herein. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. In some examples, graphics interface 640 generates a display based on data stored in memory 630 or based on operations executed by processor 610 or both. In some examples, graphics interface 640 generates a display based on data stored in memory 630 or based on operations executed by processor 610 or both.

Accelerators 642 can be a fixed function or programmable offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 642 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory.

Network interface 650 (e.g., NIC) can include one or more of: a network interface controller (NIC), a remote direct memory access (RDMA)-enabled NIC, SmartNIC, router, switch, or network-attached appliance. Some examples of network interface 650 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. For example, one or more programmable pipelines or fixed function processors or other circuitry can be configured to perform event processing using an accelerator or other circuitry in line with network interface device 650 at least where network interface device 650 is accessed using device virtualization, as described herein.

For example, network interface 650 can include Media Access Control (MAC) circuitry, a reconciliation sublayer circuitry, and physical layer interface (PHY) circuitry. The PHY circuitry can include a physical medium attachment (PMA) sublayer circuitry, Physical Medium Dependent (PMD) circuitry, a forward error correction (FEC) circuitry, and a physical coding sublayer (PCS) circuitry. In some examples, the PHY can provide an interface that includes or use a serializer de-serializer (SerDes). In some examples, at least where network interface 650 is a router or switch, the router or switch can include interface circuitry that includes a SerDes.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. A volatile memory is memory whose state (and therefore the data stored in it) is indeterminate if power is interrupted to the device. A non-volatile memory (NVM) device is a memory whose state is determinate even if power is interrupted to the device. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as Non-Volatile Memory Express over Fabrics (NVMe-oF) (e.g., NVMe-oF specification, version 1.0 (2016) as well as variations, extensions, and derivatives thereof) or NVMe (e.g., Non-Volatile Memory Express (NVMe) Specification, revision 1.3c, published on May 24, 2018 (“NVMe specification”) as well as variations, extensions, and derivatives thereof).

Communications between devices can take place using a network that provides die-to-die communications; chip-to-chip communications; circuit board-to-circuit board communications; and/or package-to-package communications. One or more components of system 600 can be implemented as part of a system-on-chip (SoC).

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, cloud and software-defined networking to deliver application workloads across physical data centers and distributed multi-cloud environments).

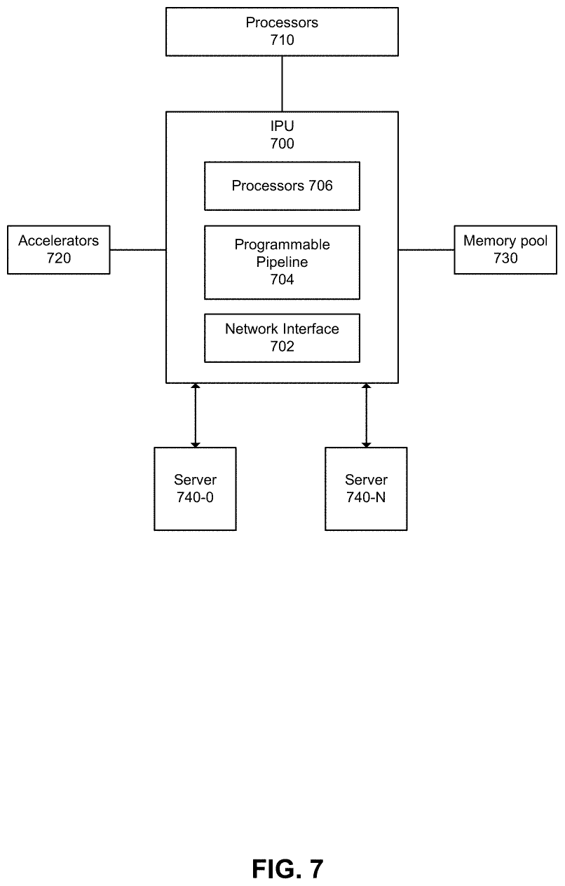

FIG. 7 depicts an example network interface device. Network interface device 700 can manage performance of one or more processes using one or more of processors 706, processors 710, accelerators 720, memory pool 730, or servers 740-0 to 740-N, where N is an integer of 1 or more. In some examples, processors 706 of network interface device 700 can execute one or more processes, applications, VMs, containers, microservices, and so forth that request performance of workloads by one or more of: processors 710, accelerators 720, memory pool 730, and/or servers 740-0 to 740-N. Network interface device 700 can utilize network interface 702 or one or more device interfaces to communicate with processors 710, accelerators 720, memory pool 730, and/or servers 740-0 to 740-N. Network interface device 700 can utilize programmable pipeline 704 to process packets that are to be transmitted from network interface 702 or packets received from network interface 702.

Programmable pipeline 704 and/or processors 706 can be configured or programmed using languages based on one or more of: P4, Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries. In some examples, an accelerator (e.g., programmable pipeline 704 and/or processors 706) can be configured to perform event processing in connection with access to network interface 702 at least where network interface 702 is accessed using device virtualization, as described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples, and includes an apparatus that includes: a host interface and circuitry, when coupled to a physical device, that is to perform operations of a hypervisor, wherein: the host interface is configured to route first communications to the circuitry instead of the physical device and route second communications to the physical device and the physical device is accessible as a virtual device via the host interface.

Example 2 includes one or more examples, wherein the operations of the hypervisor comprise perform descriptor format translation between one of multiple different device drivers and the physical device and queue semantic translation.

Example 3 includes one or more examples, wherein: an event is received via the first communications and the circuitry comprises at least two cores and circuitry to load balance and schedule event processing among the at least two cores.

Example 4 includes one or more examples, wherein an event is received via the first communications, the circuitry comprises at least one core, and the at least one core is to process the event while waiting for completion of a direct memory access (DMA) operation for another event.

Example 5 includes one or more examples, wherein the circuitry is configured to route first communications to the circuitry instead of the physical device based on incompatibility between a processor-executed driver and the physical device.

Example 6 includes one or more examples, and includes a host system communicatively coupled to the circuitry by the host interface, wherein the host system comprises one or more processors to execute an operating system and a driver to access the physical device as the virtual device.

Example 7 includes one or more examples, wherein the virtual device is accessible using virtualization based on one or more of: Single Root I/O Virtualization (SR-IOV), and/or Scalable Input/Output (I/O) Virtualization (S-IOV).

Example 8 includes one or more examples, and includes the physical device communicatively coupled to the circuitry, wherein the physical device comprises one or more of: a protocol engine, a storage controller, a network interface device, a graphics processing unit, and/or accelerator.

Example 9 includes one or more examples, and includes a method that includes a server utilizing a physical device by device virtualization and accessing an intermediary device to accelerate communication with the physical device, wherein the intermediary device performs event translation and comprises circuitry to schedule performance of events by one or more processors of the intermediary device.

Example 10 includes one or more examples, wherein the intermediary device performs event translation comprises retrieving a descriptor and performing descriptor format translation between one of multiple different device drivers and the physical device.

Example 11 includes one or more examples, wherein the intermediary device comprises at least one processor and circuitry that load balances event processing among the at least one processor.

Example 12 includes one or more examples, wherein the intermediary device comprises at least one processor and direct memory access (DMA) circuitry and the at least one processor processes an event while waiting for completion of a DMA operation for another event.

Example 13 includes one or more examples, wherein the physical device comprises one or more of: a protocol engine, a storage controller, a network interface device, a graphics processing unit, and/or accelerator.

Example 14 includes one or more examples, and includes a host system executing a driver that provides events to a host interface and the host interface is configured to route particular events to the intermediary device based on a base address register (BAR) range associated with the particular events.

Example 15 includes one or more examples, and includes a non-transitory computer-readable medium comprising instructions stored thereon, that if executed by one or more processors, cause the one or more processors to: configure circuitry of a host interface between a host system and a physical device, accessible by device virtualization, to route events to a physical device or to an intermediary device, wherein the intermediary device performs event translation and comprises circuitry to schedule performance of events by at least one processor.

Example 16 includes one or more examples, the intermediary device performs event translation comprises retrieving a descriptor and performing descriptor format translation between one of multiple different device drivers and the physical device.

Example 17 includes one or more examples, at least one event of the events comprises one or more of: translation of descriptor format into protocol-engine descriptor format or translation of descriptor format from protocol-engine descriptor format to driver format.

Example 18 includes one or more examples, the intermediary device comprises the at least one processor and direct memory access (DMA) circuitry and the at least one processor processes an event while waiting for completion of a DMA operation for another event.

Example 19 includes one or more examples, the physical device comprises one or more of: a protocol engine, a storage controller, a network interface device, a graphics processing unit, and/or accelerator.

Example 20 includes one or more examples, the device virtualization is based on one or more of: Single Root I/O Virtualization (SR-IOV), and/or Scalable Input/Output (I/O) Virtualization (S-IOV).

What is claimed is:

1. An apparatus comprising:
a host interface and
circuitry, when coupled to a physical device, that is to:
perform operations of a hypervisor, wherein:
the host interface is configured to route first communications to the circuitry instead of the physical device and route second communications to the physical device and
the physical device is accessible as a virtual device via the host interface.

2. The apparatus of claim 1, wherein the operations of the hypervisor comprise perform descriptor format translation between one of multiple different device drivers and the physical device and queue semantic translation.

3. The apparatus of claim 1, wherein:
an event is received via the first communications and
the circuitry comprises at least two cores and circuitry to load balance and schedule event processing among the at least two cores.

4. The apparatus of claim 1, wherein
an event is received via the first communications,
the circuitry comprises at least one core, and
the at least one core is to process the event while waiting for completion of a direct memory access (DMA) operation for another event.

5. The apparatus of claim 1, wherein the circuitry is configured to route first communications to the circuitry instead of the physical device based on incompatibility between a processor-executed driver and the physical device.

6. The apparatus of claim 1, comprising a host system communicatively coupled to the circuitry by the host interface, wherein the host system comprises one or more processors to execute an operating system and a driver to access the physical device as the virtual device.

7. The apparatus of claim 1, wherein the virtual device is accessible using virtualization based on one or more of: Single Root I/O Virtualization (SR-IOV), and/or Scalable Input/Output (I/O) Virtualization (S-IOV).

8. The apparatus of claim 1, comprising the physical device communicatively coupled to the circuitry, wherein the physical device comprises one or more of: a protocol engine, a storage controller, a network interface device, a graphics processing unit, and/or accelerator.

9. A method comprising:
a server utilizing a physical device by device virtualization and accessing an intermediary device to accelerate communication with the physical device, wherein the intermediary device performs event translation and comprises circuitry to schedule performance of events by one or more processors of the intermediary device.

10. The method of claim 9, wherein the intermediary device performs event translation comprises retrieving a descriptor and performing descriptor format translation between one of multiple different device drivers and the physical device.

11. The method of claim 9, wherein the intermediary device comprises at least one processor and circuitry that load balances event processing among the at least one processor.

12. The method of claim 9, wherein the intermediary device comprises at least one processor and direct memory access (DMA) circuitry and the at least one processor processes an event while waiting for completion of a DMA operation for another event.

13. The method of claim 9, wherein the physical device comprises one or more of: a protocol engine, a storage controller, a network interface device, a graphics processing unit, and/or accelerator.

14. The method of claim 9, comprising:
a host system executing a driver that provides events to a host interface and the host interface is configured to route particular events to the intermediary device based on a base address register (BAR) range associated with the particular events.

15. A non-transitory computer-readable medium comprising instructions stored thereon, that if executed by one or more processors, cause the one or more processors to:
configure circuitry of a host interface between a host system and a physical device, accessible by device virtualization, to route events to a physical device or to an intermediary device, wherein the intermediary device performs event translation and comprises circuitry to schedule performance of events by at least one processor.

16. The non-transitory computer-readable medium of claim 15, wherein the intermediary device performs event translation comprises retrieving a descriptor and performing descriptor format translation between one of multiple different device drivers and the physical device.

17. The non-transitory computer-readable medium of claim 15, wherein at least one event of the events comprises one or more of: translation of descriptor format into protocol-engine descriptor format or translation of descriptor format from protocol-engine descriptor format to driver format.

18. The non-transitory computer-readable medium of claim 15, wherein the intermediary device comprises the at least one processor and direct memory access (DMA) circuitry and the at least one processor processes an event while waiting for completion of a DMA operation for another event.

19. The non-transitory computer-readable medium of claim 15, wherein the physical device comprises one or more of: a protocol engine, a storage controller, a network interface device, a graphics processing unit, and/or accelerator.

20. The non-transitory computer-readable medium of claim 15, wherein the device virtualization is based on one or more of: Single Root I/O Virtualization (SR-IOV), and/or Scalable Input/Output (I/O) Virtualization (S-IOV).
